(19) United States
(12) Patent Application Publication
(10) Pub. No.: US 2024/0119960 A1
(43) Pub. Date: Apr. 11, 2024

(54) ELECTRONIC DEVICE AND METHOD OF RECOGNIZING VOICE

(71) Applicant: SAMSUNG ELECTRONICS CO., LTD., Suwon-si (KR)

(72) Inventors: Hyunwoong LIM, Suwon-si (KR); Kyungtae KIM, Suwon-si (KR); Gajin SONG, Suwon-si (KR)

(73) Assignee: SAMSUNG ELECTRONICS CO., LTD., Suwon-si (KR)

(21) Appl. No.: 18/543,845

(22) Filed: Dec. 18, 2023

Related U.S. Application Data
(63) Continuation of application No. PCT/KR23/11016, filed on Jul. 28, 2023.

(30) Foreign Application Priority Data
Aug. 5, 2022 (KR) 10-2022-0098108
Sep. 5, 2022 (KR) 10-2022-0112217

(51) Int. Cl. G10L 25/78

(52) U.S. Cl. CPC G10L 25/78

(57) ABSTRACT

Provided is an electronic device and a voice recognition method. The electronic device includes: a memory configured to store at least one instruction, and a processor electrically connected to the memory. The processor is and configured to execute the at least one instruction to: obtain a sound signal corresponding to an utterance, and recognize a voice signal included in the sound signal, based on a determination that a portion of the sound signal corresponds to at least one of a plurality of noise categories, the plurality of noise categories corresponding to a plurality of environments in which a plurality of voice models of voice signals are generated.

### CROSS-REFERENCE TO RELATED APPLICATIONS

This application is a bypass continuation of PCT International Application No. PCT/KR2023/011016 designating the United States, which was filed on Jul. 28, 2023, and claims priority to Korean Patent Application No. 10-2022-0098108, filed on Aug. 5, 2022, and Korean Patent Application No. 10-2022-0112217, filed on Sep. 5, 2022, in the Korean Intellectual Property Office, the disclosures of which are incorporated by reference herein in their entireties.

### BACKGROUND

### 1. Field

The disclosure relates to an electronic device and a method of recognizing a voice.

### 2. Description of Related Art

A user may receive various services using an electronic device. With the development of speech recognition technology, a user may input a voice (e.g., an utterance) into an electronic device and receive a response message according to the input voice through a voice assistant (e.g., a voice assistant service).

In addition, the electronic device may perform functions or support another electronic device (e.g., an Internet of things (IoT) device) to perform functions, based on the voice assistant recognizing the input voice (e.g., a voice wakeup command). Voice wakeup command-based device control may include understanding a user's intent from the voice wakeup command and executing a device command desired by the user.

### SUMMARY

According to an aspect of the disclosure, an electronic device includes: a memory configured to store at least one instruction; and a processor electrically connected to the memory and configured to execute the at least one instruction to: obtain a sound signal corresponding to an utterance, and recognize a voice signal included in the sound signal, based on a determination that a portion of the sound signal corresponds to at least one of a plurality of noise categories, the plurality of noise categories corresponding to a plurality of environments in which a plurality of voice models of voice signals are generated.

According to an aspect of the disclosure, an electronic device includes: a memory configured to store at least one instruction; and a processor electrically connected to the memory and configured to execute the at least one instruction to: determine whether a noise category of a background noise signal included in a sound signal corresponds to at least one of a plurality of noise categories, the plurality of noise categories corresponding to a plurality of environments in which a plurality of voice models of voice signals are generated, obtain a voice model of a voice signal included in the sound signal based on a determination that the noise category of the background noise signal corresponds to the at least one of the plurality of noise categories, and recognize the voice signal using the obtained voice model.

According to an aspect of the disclosure, a method of operating an electronic device includes: obtaining a sound signal corresponding to an utterance; and recognizing a voice signal included in the sound signal, based on a determination that a portion of the sound signal corresponds to at least one of a plurality of noise categories, the plurality of noise categories corresponding to a plurality of environments in which a plurality of voice models of voice signals are generated.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an electronic device in a network environment, according to an embodiment;

FIG. 2 is a block diagram illustrating an integrated intelligence system, according to an embodiment;

FIG. 3 is a diagram illustrating relationship information between concepts and actions stored in a database, according to an embodiment;

FIG. 4 is a diagram illustrating a screen of an electronic device processing a received voice input through an intelligent app, according to an embodiment;

FIG. 5 is a diagram illustrating a voice recognition method, according to an embodiment;

FIG. 6 is a block diagram illustrating an operation of an electronic device recognizing a voice in an environment different from an environment in which the voice is recorded, according to an embodiment;

FIG. 7 is a diagram illustrating a sound signal including a voice signal and a background noise signal, according to an embodiment;

FIG. 8 is a flowchart illustrating a method of operating an electronic device, according to an embodiment;

FIG. 9 is a flowchart illustrating operations of an electronic device obtaining a voice model of a voice signal, according to an embodiment; and

FIG. 10 is a diagram illustrating a plurality of noise models and a plurality of voice models, according to an embodiment.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted.

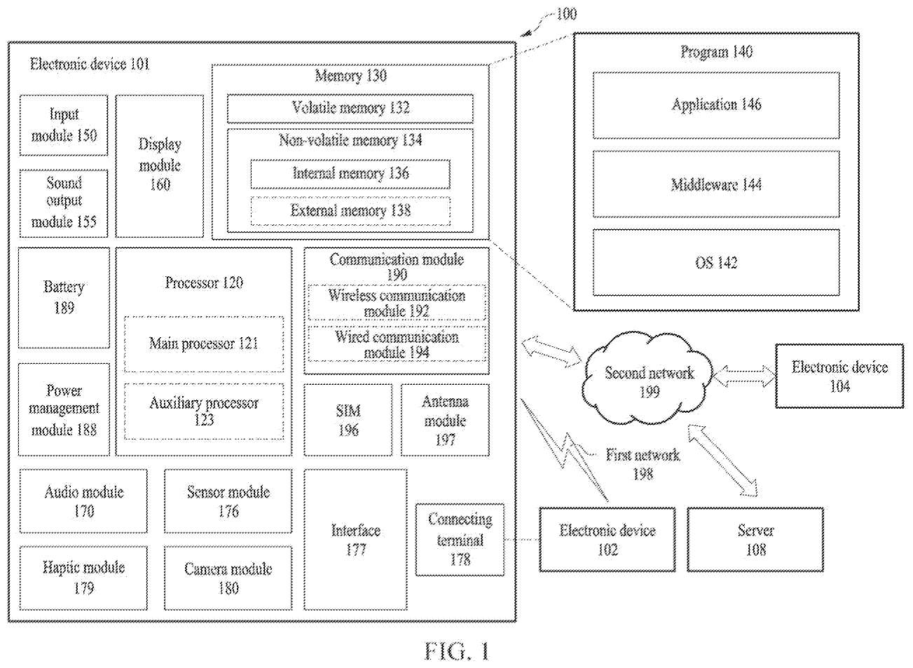

FIG. 1 is a block diagram illustrating an electronic device 101 in a network environment 100, according to an embodiment.

Referring to FIG. 1, the electronic device 101 in the network environment 100 may communicate with an external electronic device 102 via a first network 198 (e.g., a short-range wireless communication network), or communicate with at least one of an external electronic device 104 or a server 108 via a second network 199 (e.g., a long-range wireless communication network). According to an embodiment, the electronic device 101 may communicate with the external electronic device 104 via the server 108. According to an embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the above components may be omitted from the electronic device 101, or one or more other components may be added to the electronic device 101. In some embodiments, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an embodiment, as at least part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for processing of an artificial intelligence model. The artificial intelligence model may be generated by machine learning. Such learning may be performed by, for example, the electronic device 101 in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment, the display module 160 may include a touch sensor adapted to detect a touch, or a pressure sensor adapted to measure the intensity of force incurred by the touch.

The audio module 170 may convert a sound into an electric signal or vice versa. According to an embodiment, the audio module 170 may obtain the sound via the input module 150, or output the sound via the sound output module 155 (e.g., a speaker or a headphone) or an external electronic device (e.g., the external electronic device 102) directly or wirelessly connected to the electronic device 101.

The sensor module 176 may detect an operational state (e.g., power or temperature) of the electronic device 101 or an environmental state (e.g., a state of a user) external to the electronic device 101, and generate an electric signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the external electronic device 102). According to an embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, image signal processors, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more CPs that are operable independently of the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the external electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to an embodiment, the antenna module 197 may form a mmWave antenna module. According to an embodiment, the mmWave antenna module may include a PCB, an RFIC disposed on a first surface (e.g., a bottom surface) of the PCB or adjacent to the first surface and capable of supporting a designated high-frequency band (e.g., the mmWave band), and a plurality of antennas (e.g., array antennas) disposed on a second surface (e.g., a top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and one or more external electronic devices (e.g., external electronic device 102, external electronic device 104) via the server 108 coupled with the second network 199. Each of the external electronic device 102 or external electronic device 104 may be a device of the same type as or a different type from the electronic device 101. According to an embodiment, all or some of operations to be executed by the electronic device 101 may be executed at one or more external electronic devices (e.g., the external device 102, external electronic device 104, and the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

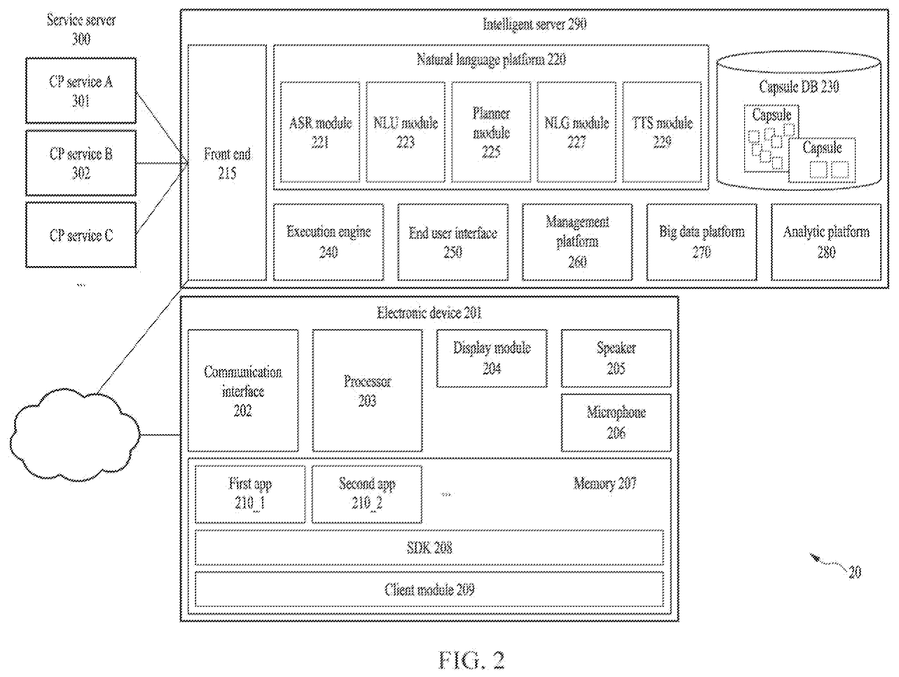

FIG. 2 is a block diagram illustrating an integrated intelligence system, according to an embodiment.

Referring to FIG. 2, an integrated intelligence system 20 according to an embodiment may include an electronic device 201 (e.g., the electronic device 101 of FIG. 1), an intelligent server 290 (e.g., the server 108 of FIG. 1), and a service server 300 (e.g., the server 108 of FIG. 1).

The electronic device 201 may be a terminal device (or an electronic device) connectable to the Internet, and may be, for example, a mobile phone, a smartphone, a personal digital assistant (PDA), a notebook computer, a TV, a white home appliance, a wearable device, a head-mounted display (HMD), or a smart speaker.

As shown in FIG. 2, the electronic device 201 may include a communication interface 202 (e.g., the interface 177 of FIG. 1), a microphone 206 (e.g., the input module 150 of FIG. 1), a speaker 205 (e.g., the sound output module 155 of FIG. 1), a display module 204 (e.g., the display module 160 of FIG. 1), a memory 207 (e.g., the memory 130 of FIG. 1), or a processor 203 (e.g., the processor 120 of FIG. 1). The components listed above may be operationally or electrically connected to each other.

The communication interface 202 may be connected to an external device and configured to transmit and receive data to and from the external device. The microphone 206 may receive a sound (e.g., a user utterance) and convert the sound into an electrical signal. The speaker 205 may output the electrical signal as a sound (e.g., a voice).

The display module 204 may be configured to display an image or video. The display module 204 may also display a graphical user interface (GUI) of an app (or an application program) being executed. The display module 204 may receive a touch input through a touch sensor. For example, the display module 204 may receive a text input through a touch sensor in an on-screen keyboard area displayed in the display module 204.

The memory 207 may store a client module 209, a software development kit (SDK) 208, and a plurality of apps 210. The client module 209 and the SDK 208 may configure a framework (or a solution program) for performing general-purpose functions. In addition, the client module 209 or the SDK 208 may configure a framework for processing a user input (e.g., a voice input, a text input, or a touch input).

The plurality of apps 210 stored in the memory 207 may be programs for performing designated functions. According to an embodiment, the plurality of apps 210 may include a first app 210_1, a second app 210_2, and the like. According to an embodiment, each of the plurality of apps 210 may include a plurality of actions for performing a designated function. For example, the apps may include an alarm app, a messaging app, and/or a scheduling app. According to an embodiment, the plurality of apps 210 may be executed by the processor 203 to sequentially execute at least a portion of the plurality of actions.

The processor 203 may control the overall operation of the electronic device 201. For example, the processor 203 may be electrically connected to the communication interface 202, the microphone 206, the speaker 205, and the display module 204 to perform a designated operation.

The processor 203 may also perform the designated function by executing the program stored in the memory 207. For example, the processor 203 may execute at least one of the client module 209 or the SDK 208 to perform the following operation for processing a user input. The processor 203 may control the operation of the plurality of apps 210 through, for example, the SDK 208. The following operation which is the operation of the client module 209 or the SDK 208 may be performed by the processor 203.

The client module 209 may receive a user input. For example, the client module 209 may receive a voice signal corresponding to a user utterance sensed through the microphone 206. As another example, the client module 209 may receive a touch input sensed through the display module 204. As still another example, the client module 209 may receive a text input sensed through a keyboard or an on-screen keyboard. In addition, the client module 209 may receive various types of user inputs sensed through an input module included in the electronic device 201 or an input module connected to the electronic device 201. The client module 209 may transmit the received user input to the intelligent server 290. The client module 209 may transmit state information of the electronic device 201 together with the received user input to the intelligent server 290. The state information may be, for example, execution state information of an app.

The client module 209 may receive a result corresponding to the received user input. For example, when the intelligent server 290 is capable of calculating a result corresponding to the received user input, the client module 209 may receive the result corresponding to the received user input. The client module 209 may display the received result on the display module 204. Further, the client module 209 may output the received result in an audio form through the speaker 205.

The client module 209 may receive a plan corresponding to the received user input. The client module 209 may display results of executing a plurality of actions of an app according to the plan on the display module 204. For example, the client module 209 may sequentially display the results of executing the plurality of actions on the display module 204 and output the results in an audio form through the speaker 205. As another example, the electronic device 201 may display only a partial result of executing the plurality of actions (e.g., a result of the last action) on the display module 204 and output the partial result in an audio form through the speaker 205.

According to an embodiment, the client module 209 may receive a request for obtaining information necessary for calculating a result corresponding to the user input from the intelligent server 290. According to an embodiment, the client module 209 may transmit the necessary information to the intelligent server 290 in response to the request.

The client module 209 may transmit information on the results of executing the plurality of actions according to the plan to the intelligent server 290. The intelligent server 290 may confirm that the received user input has been correctly processed using the information on the results.

The client module 209 may include a speech recognition module. According to an embodiment, the client module 209 may recognize a voice input for performing a limited function through the speech recognition module. For example, the client module 209 may execute an intelligent app for processing a voice input to perform an organic operation through a designated input (e.g., Wake up!).

The intelligent server 290 may receive information related to a user voice input from the electronic device 201 through a communication network. According to an embodiment, the intelligent server 290 may change data related to the received voice input into text data. According to an embodiment, the intelligent server 290 may generate a plan for performing a task corresponding to the user voice input based on the text data.

According to an embodiment, the plan may be generated by an artificial intelligence (AI) system. The artificial intelligence system may be a rule-based system or a neural network-based system (e.g., a feedforward neural network (FNN) or a recurrent neural network (RNN)). Alternatively, the artificial intelligence system may be a combination thereof or other artificial intelligence systems. According to an embodiment, the plan may be selected from a set of predefined plans or may be generated in real time in response to a user request. For example, the artificial intelligence system may select at least one plan from among the predefined plans.

The intelligent server 290 may transmit a result according to the generated plan to the electronic device 201 or transmit the generated plan to the electronic device 201. According to an embodiment, the electronic device 201 may display the result according to the plan on the display. According to an embodiment, the electronic device 201 may display a result of executing an action according to the plan on the display.

The intelligent server 290 may include a front end 215, a natural language platform 220, a capsule database (DB) 230, an execution engine 240, an end user interface (UI) 250, a management platform 260, a big data platform 270, or an analytic platform 280.

The front end 215 may receive the received user input from the electronic device 201. The front end 215 may transmit a response corresponding to the user input.

According to an embodiment, the natural language platform 220 may include an automatic speech recognition (ASR) module 221, a natural language understanding (NLU) module 223, a planner module 225, a natural language generator (NLG) module 227, or a text-to-speech (TTS) module 229.

The ASR module 221 may convert the voice input received from the electronic device 201 into text data. The NLU module 223 may discern an intent of a user using the text data of the voice input. For example, the NLU module 223 may discern the intent of the user by performing syntactic analysis or semantic analysis on a user input in the form of text data. The NLU module 223 may discern the meaning of a word extracted from the user input using a linguistic feature (e.g., a grammatical element) of a morpheme or phrase, and determine the intent of the user by matching the discerned meaning of the word to an intent.

The planner module 225 may generate a plan using a parameter and the intent determined by the NLU module 223. According to an embodiment, the planner module 225 may determine a plurality of domains required to perform a task based on the determined intent. The planner module 225 may determine a plurality of actions included in each of the plurality of domains determined based on the intent. According to an embodiment, the planner module 225 may determine a parameter required to execute the determined plurality of actions or a result value output by the execution of the plurality of actions. The parameter and the result value may be defined as a concept of a designated form (or class). Accordingly, the plan may include a plurality of actions and a plurality of concepts determined by the user intent. The planner module 225 may determine a relationship between the plurality of actions and the plurality of concepts stepwise (or hierarchically). For example, the planner module 225 may determine an execution order of the plurality of actions determined based on the user intent, based on the plurality of concepts. In other words, the planner module 225 may determine the execution order of the plurality of actions based on the parameter required for the execution of the plurality of actions and results output by the execution of the plurality of actions. Accordingly, the planner module 225 may generate a plan including connection information (e.g., ontology) between the plurality of actions and the plurality of concepts. The planner module 225 may generate the plan using information stored in the capsule DB 230 that stores a set of relationships between concepts and actions.

The NLG module 227 may change designated information into a text form. The information changed to the text form may be in the form of a natural language utterance. The TTS module 229 may change information in a text form into information in a speech form.

According to an embodiment, some or all of the functions of the natural language platform 220 may be implemented in the electronic device 201 as well.

The capsule DB 230 may store information on the relationship between the plurality of concepts and actions corresponding to the plurality of domains. A capsule according to an embodiment may include a plurality of action objects (or action information) and concept objects (or concept information) included in the plan. According to an embodiment, the capsule DB 230 may store a plurality of capsules in the form of a concept action network (CAN). According to an embodiment, the plurality of capsules may be stored in a function registry included in the capsule DB 230.

The capsule DB 230 may include a strategy registry that stores strategy information necessary for determining a plan corresponding to a voice input. The strategy information may include reference information for determining one plan when there are a plurality of plans corresponding to the user input. According to an embodiment, the capsule DB 230 may include a follow-up registry that stores information on follow-up actions for suggesting a follow-up action to the user in a designated situation. The follow-up action may include, for example, a follow-up utterance. According to an embodiment, the capsule DB 230 may include a layout registry that stores layout information that is information output through the electronic device 201. According to an embodiment, the capsule DB 230 may include a vocabulary registry that stores vocabulary information included in capsule information. According to an embodiment, the capsule DB 230 may include a dialog registry that stores information on a dialog (or an interaction) with the user. The capsule DB 230 may update the stored objects through a developer tool. The developer tool may include, for example, a function editor for updating an action object or a concept object. The developer tool may include a vocabulary editor for updating the vocabulary. The developer tool may include a strategy editor for generating and recording a strategy for determining a plan. The developer tool may include a dialog editor for generating a dialog with the user. The developer tool may include a follow-up editor for activating a follow-up objective and editing a follow-up utterance that provides a hint. The follow-up objective may be determined based on a current set objective, a preference of the user, or an environmental condition. In an embodiment, the capsule DB 230 may be implemented in the electronic device 201 as well.

The execution engine 240 may calculate a result using the generated plan. The end UI 250 may transmit the calculated result to the electronic device 201. Accordingly, the electronic device 201 may receive the result and provide the received result to the user. The management platform 260 may manage information used by the intelligent server 290. The big data platform 270 may collect data of the user. The analytic platform 280 may manage a quality of service (QoS) of the intelligent server 290. For example, the analytic platform 280 may manage the components and processing rate (or efficiency) of the intelligent server 290.

The service server 300 may provide a designated service (e.g., food order or hotel reservation) to the electronic device 201. According to an embodiment, the service server 300 may be a server operated by a third party. The service server 300 may provide information to be used for generating a plan corresponding to the received user input to the intelligent server 290. The provided information may be stored in the capsule DB 230. In addition, the service server 300 may provide result information according to the plan to the intelligent server 290.

In the integrated intelligence system 20 described above, the electronic device 201 may provide various intelligent services to the user in response to a user input. The user input may include, for example, an input through a physical button, a touch input, or a voice input.

In an embodiment, the electronic device 201 may provide a speech recognition service through an intelligent app (or a speech recognition app) stored therein. In this case, for example, the electronic device 201 may recognize a user utterance or a voice input received through the microphone, and provide a service corresponding to the recognized voice input to the user.

In an embodiment, the electronic device 201 may perform a designated action alone or together with the intelligent server and/or a service server, based on the received voice input. For example, the electronic device 201 may execute an app corresponding to the received voice input and perform a designated action through the executed app.

In an embodiment, when the electronic device 201 provides a service together with the intelligent server 290 and/or the service server, the electronic device 201 may detect a user utterance using the microphone 206 and generate a signal (or voice data) corresponding to the detected user utterance. The electronic device 201 may transmit the speech data to the intelligent server 290 using the communication interface 202.

The intelligent server 290 may generate, as a response to the voice input received from the electronic device 201, a plan for performing a task corresponding to the voice input or a result of performing an action according to the plan. The plan may include, for example, a plurality of actions for performing a task corresponding to a voice input of a user, and a plurality of concepts related to the plurality of actions. The concepts may define parameters input to the execution of the plurality of actions or result values output by the execution of the plurality of actions. The plan may include connection information between the plurality of actions and the plurality of concepts.

The electronic device 201 may receive the response using the communication interface 202. The electronic device 201 may output a speech signal generated in the electronic device 201 to the outside using the speaker 205, or output an image generated in the electronic device 201 to the outside using the display module 204.

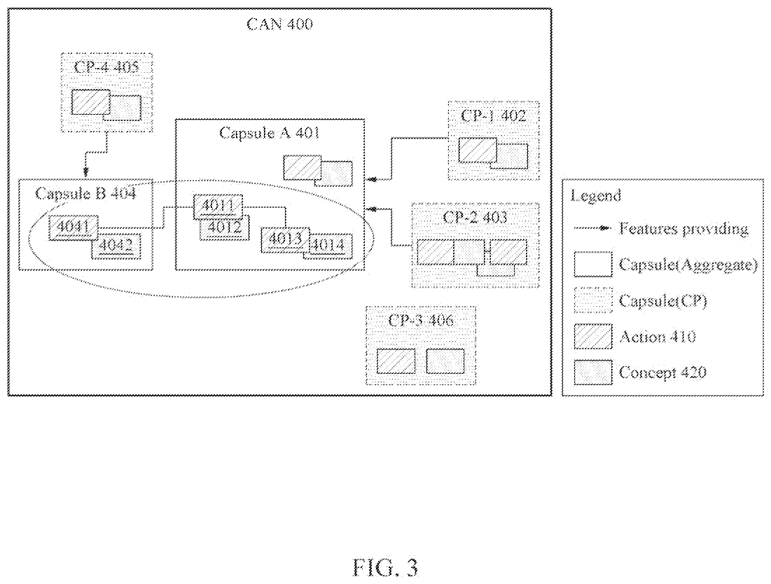

FIG. 3 is a diagram illustrating relationship information between concepts and actions is stored in a DB, according to an embodiment.

A capsule DB (e.g., the capsule DB 230) of the intelligent server 290 may store capsules in the form of a CAN. The capsule DB may store an action for processing a task corresponding to a voice input of a user and a parameter required for the action in the form of a CAN.

The capsule DB may store a plurality of capsules (e.g., capsule A 401 and capsule B 404) respectively corresponding to a plurality of domains (e.g., applications). According to an embodiment, a capsule (e.g., the capsule A 401) may correspond to one domain (e.g., a location (geo) or an application). Further, the capsule may correspond to at least one service provider (e.g., CP-1 402 or CP-2 403) for performing a function for a domain related to the capsule. According to an embodiment, a capsule may include at least one action 410 for performing a designated function and at least one concept 420.

The natural language platform 220 may generate a plan for performing a task corresponding to the received voice input using the capsules stored in the capsule DB. For example, the planner module 225 of the natural language platform 220 may generate the plan using the capsules stored in the capsule DB. For example, a plan may be generated using actions 4011 and 4013 and concepts 4012 and 4014 of the capsule A 401 and an action 4041 and a concept 4042 of the capsule B 404.

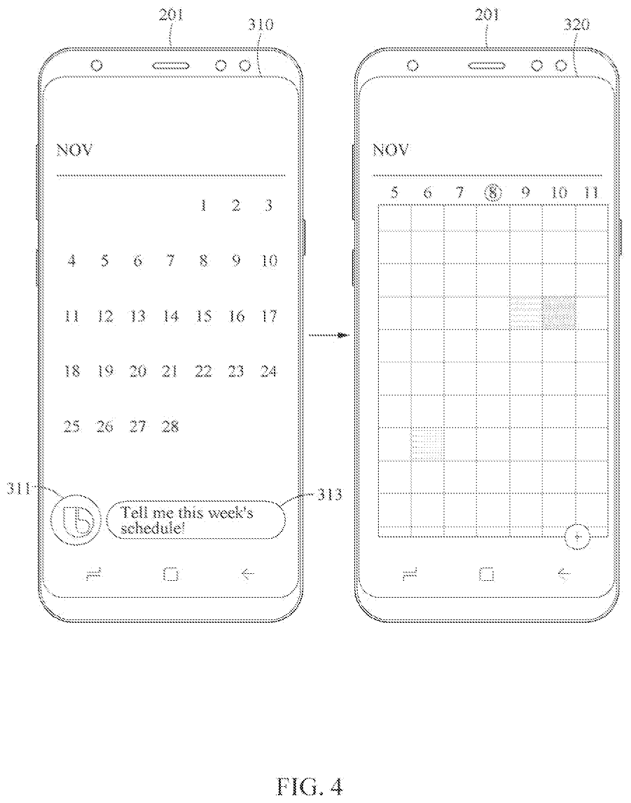

FIG. 4 is a diagram illustrating a screen of an electronic device processing a received voice input through an intelligent app, according to an embodiment.

The electronic device 201 may execute an intelligent app to process a user input through the intelligent server 290.

According to an embodiment, on a screen 310, when a designated voice input (e.g., Wake up!) is recognized or an input through a hardware key (e.g., a dedicated hardware key) is received, the electronic device 201 may execute an intelligent app for processing the voice input. The electronic device 201 may execute the intelligent app, for example, in a state in which a scheduling app is executed. According to an embodiment, the electronic device 201 may display an object (e.g., an icon 311) corresponding to the intelligent app on the display module 204. According to an embodiment, the electronic device 201 may receive a voice input by a user utterance. For example, the electronic device 201 may receive a voice input of “Tell me this week's schedule!”. According to an embodiment, the electronic device 201 may display a UI 313 (e.g., an input window) of the intelligent app in which text data of the received voice input is displayed on the display.

According to an embodiment, on a screen 320, the electronic device 201 may display a result corresponding to the received voice input on the display. For example, the electronic device 201 may receive a plan corresponding to the received user input, and display “this week's schedule” on the display according to the plan.

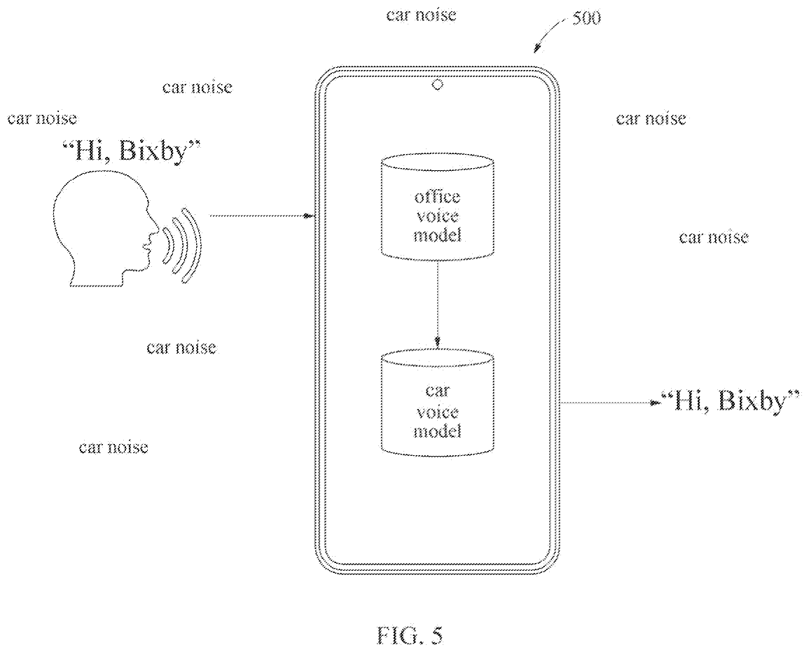

FIG. 5 is a diagram illustrating a voice recognition method, according to an embodiment.

Referring to FIG. 5, an electronic device 500 (e.g., the electronic device 101 of FIG. 1 or the electronic device 201 of FIG. 2) may respond to a voice wakeup command of a voice of a speaker, who recorded the voice, based on speaker verification. The electronic device 500 may obtain (e.g., select, generate) a voice model for the voice wakeup command using the recorded voice, and classify and verify a speaker of the recorded voice by using the obtained voice model, to recognize the voice wakeup command and respond to the voice wakeup command. For example, the electronic device 500 may determine the obtained voice model as a voice recognition model. The electronic device 500 may load the voice recognition model into a voice recognition module and recognize a voice wakeup command by using the voice recognition module into which the voice recognition model is loaded. In the electronic device 500, when a speaker records a voice on the electronic device, noise generated in the environment, in which the voice is recorded, naturally flows into the recorded voice, and the voice recognition model may show excellent voice recognition performance with respect to the noise generated in the environment in which the voice is recorded.

According to an embodiment, the electronic device 500 may maintain or improve voice wakeup command recognition performance in an environment different from the environment in which the voice of the speaker, who recorded the voice, was recorded (e.g., a voice recording environment). For example, the electronic device 500 may recognize the voice wakeup command of the speaker who recorded a voice and respond to the voice wakeup command in a first environment, and the electronic device 500 may maintain or improve voice wakeup command recognition performance in a second environment different from the first environment based on the voice recognition in the first environment. In another example, the electronic device 500 may not recognize the voice wakeup command of others except for the speaker, who recorded the voice, and may not respond to the voice wakeup command, even in an environment different from the voice recording environment.

According to an embodiment, when a speaker (e.g., a user of the electronic device 500) recorded a voice in an office, the voice wakeup command recognition performance of the electronic device 500 may be similarly maintained in an environment similar to the office in which the voice was recorded. For example, in the electronic device 500, a voice model generated based on the voice recording environment (e.g., an office) may be loaded into the voice recognition model by default. When the voice wakeup command (e.g., “Hi, Bixby”) is recognized in the office, the electronic device 500 may recognize the voice wakeup command (e.g., “Hi, Bixby”) and respond to the voice wakeup command using the voice recognition model (e.g., the voice recognition model into which the voice model generated based on the office is loaded).

According to an embodiment, when the speaker recorded a voice in an office, the electronic device 500 may maintain or improve the voice wakeup command recognition performance even in an environment other than the office (e.g., outdoors, in a car, cafe, etc.). For example, in the electronic device 500, the voice model generated based on the voice recording environment (e.g., an office) may be determined as the voice recognition model and loaded into the voice recognition module by default. When it is required to recognize the voice wakeup command (e.g., “Hi, Bixby”) in an environment (e.g., in a car) different from the voice recording environment, the electronic device 500 may obtain (e.g., select and/or generate) a noise category of the different environment (e.g., in a car) and obtain a voice model of the different environment based on the noise category of the different environment, without using the voice recognition model that is loaded by default (e.g., the voice model generated based on the office). The electronic device 500 may determine the voice model of the different environment as the voice recognition model and load the voice recognition model into the voice recognition module. The electronic device 500 may recognize the voice wakeup command (e.g., “Hi, Bixby”) and respond to the voice wakeup command by using the corresponding voice recognition model (e.g., the voice model of the different environment that is newly determined as the voice recognition model).

According to an embodiment, when a speaker recorded a voice in an office (voice recording environment), the electronic device 500 may maintain or improve the voice wakeup command recognition performance in a different environment in which the speaker inputs the voice wakeup command. The different environment in which the speaker inputs the voice wakeup command may be an office that is different from the voice recording environment due to a flow of a noise (e.g., the noise of an air conditioner or a fan), unlike the office environment when the voice was recorded. For example, in the electronic device 500, a voice model generated based on the voice recording environment (e.g., an office) may be determined as the voice recognition model and loaded into the voice recognition module by default. When the voice wakeup command (e.g., “Hi, Bixby”) is recognized in an environment different from the voice recording environment (e.g., an office with the noise of an air conditioner), the electronic device 500 may obtain (e.g., select and/or generate) a noise category of the environment different from the voice recording environment (e.g., an office with the noise of an air conditioner), and obtain a voice model of the environment different from the voice recording environment based on the noise category of the environment different from the voice recording environment, without using the voice recognition model loaded by default (e.g., the voice model generated based on the office). The electronic device 500 may determine the voice model of the environment different from the voice recording environment as the voice recognition model and load the voice recognition model into the voice recognition module. The electronic device 500 may recognize the voice wakeup command (e.g., “Hi, Bixby”) and respond to the voice wakeup command by using the corresponding voice recognition model (e.g., the voice model of the different environment that is newly determined as the voice recognition model).

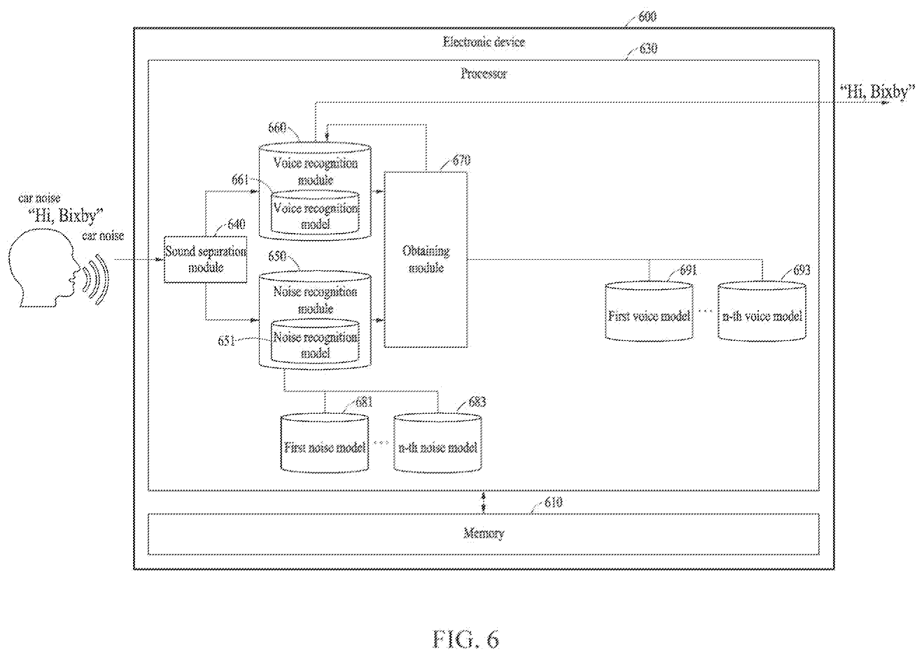

FIG. 6 is a block diagram illustrating an operation of an electronic device recognizing a voice in an environment different from an environment in which the voice is recorded, according to an embodiment.

Referring to FIG. 6, an electronic device 600 (e.g., the electronic device 101 of FIG. 1, the electronic device 201 of FIG. 2, or the electronic device 500 of FIG. 5) may include a memory 610 and a processor 630.

According to an embodiment, the memory 610 may store instructions (e.g., a program) executable by the processor 630. For example, the instructions may include instructions for performing an operation of the processor 630 and/or an operation of each component of the processor 630.

According to an embodiment, the memory 610 may be implemented as a volatile memory device or a non-volatile memory device. The volatile memory device may be implemented as a dynamic random access memory (DRAM), a static random access memory (SRAM), a thyristor RAM (T-RAM), a zero capacitor RAM (Z-RAM), or a twin transistor RAM (TTRAM). The non-volatile memory device may be implemented as an electrically erasable programmable read-only memory (EEPROM), a flash memory, a magnetic random-access memory (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate memory (NFGM), a holographic memory, a molecular electronic memory device, and/or an insulator resistance change memory.

According to an embodiment, the processor 630 may execute a computer-readable code (e.g., software) stored in the memory 610 and instructions triggered by the processor 630. The processor 630 may be a hardware-implemented data processing device having a circuit that is physically structured to execute desired operations. The desired operations may include, for example, code or instructions included in a program. For example, the hardware-implemented data processing device may include a microprocessor, a CPU, a processor core, a multi-core processor, a multiprocessor, an application-specific integrated circuit (ASIC), and a field-programmable gate array (FPGA).

According to an embodiment, the processor 630 may include a sound separation module 640, a noise recognition module 650, a noise recognition model 651, a voice recognition module 660, a voice recognition model 661, an obtaining module 670, a plurality of noise models (e.g., the first noise model 681 to the n-th noise model 683), and a plurality of voice models (e.g., the first voice model 691 to the n-th voice model 693). Here, “n” may be a natural number greater than or equal to “1”. The processor 630 may recognize a voice signal included in a sound signal corresponding to an utterance (e.g., a voice wakeup command, for example, “Hi, Bixby”) of a speaker (e.g., a user of the electronic device 600) in all environments including an environment (e.g., a voice recording environment) in which a voice of the speaker, who recorded the voice, was recorded.

According to an embodiment, the processor 630 may recognize a voice signal included in a sound signal corresponding to an utterance (e.g., the voice wakeup command, for example, “Hi, Bixby”) of the speaker in all environments including the voice recording environment, based on each component (e.g., the sound separation module 640, the noise recognition module 650, the noise recognition model 651, the voice recognition module 660, the voice recognition model 661, the obtaining module 670, a plurality of noise categories, the plurality of noise models (e.g., the first noise model 681 to the n-th noise model 683), and the plurality of voice models (e.g., the first voice model 691 to the n-th voice model 693)).

According to an embodiment, the processor 630 may obtain a sound signal corresponding to an utterance (e.g., the voice wakeup command, for example, “Hi, Bixby”) of a speaker. The processor 630 may separate a background noise signal from the sound signal. The processor 630 may determine whether a portion of the sound signal (e.g., the background noise signal) corresponds to at least one of the plurality of noise categories. The processor 630 may obtain (e.g., select or generate) a noise category of the background noise signal based on the determination of whether the background noise signal corresponds to at least one of the noise categories. The plurality of noise categories may correspond to a plurality of environments in which the voice models (e.g., the first voice model 691 to the n-th voice model 693) of the voice signal are generated. The processor 630 may obtain (e.g., select or generate) a noise model of the background noise signal and a voice model of the voice signal based on the noise category of the background noise signal. The processor 630 may determine the obtained noise model as the noise recognition model 651 and determine the obtained voice model as the voice recognition model 661. The plurality of noise categories may have a one-to-one relationship with the plurality of voice models (e.g., the first voice model 691 to the n-th voice model 693).

According to an embodiment, the processor 630 may recognize a voice signal using the obtained voice model (e.g., the voice recognition model 661). For example, the processor 630 may load the voice recognition model 661 into the voice recognition module 660. The processor 630 may recognize a voice signal using the voice recognition module 660 into which the voice recognition model 661 is loaded.

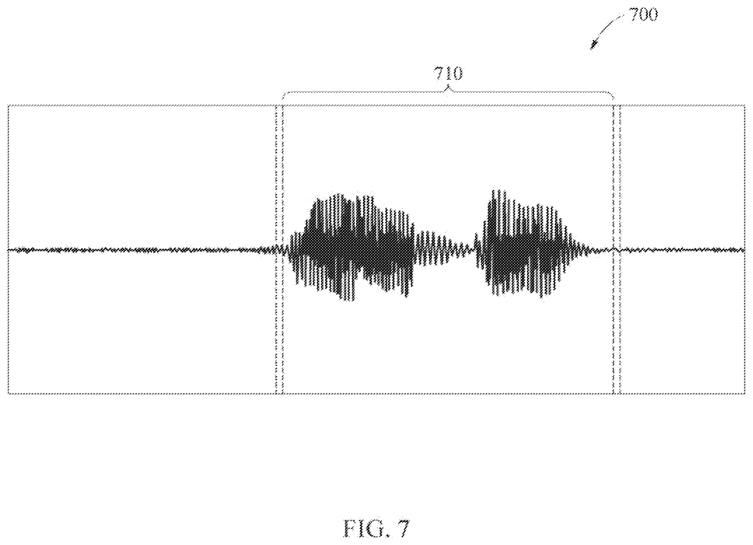

According to an embodiment, the sound separation module 640 may obtain (e.g., collect) a sound signal corresponding to an utterance (e.g., the voice wakeup command, for example, “Hi, Bixby”) of a speaker (e.g., a user of the electronic device 600). The sound signal may include a voice section (e.g., a voice section 710 of FIG. 7) including the voice signal, which will be described below with reference to FIG. 7, and a noise section not including the voice signal.

According to an embodiment, the sound separation module 640 may separate the background noise signal from the sound signal. The sound separation module 640 may separate the background noise signal from the sound signal using voice activity detection (VAD) and/or features of the sound signal (e.g., a spectrum, spectral envelope, mel-frequency cepstral coefficient (MFCC), zero-crossing rate, and power). The sound separation module 640 may transmit the background noise signal to the noise recognition module 650. The sound separation module 640 may extract a voice signal from the voice section and extract a background noise signal from the noise section. The sound separation module 640 may transmit the voice signal to the voice recognition module 660.

According to an embodiment, the noise recognition module 650 may recognize the background noise signal. The noise recognition module 650 may determine whether the background noise signal corresponds to the plurality of noise categories. For example, the noise recognition module 650 may determine whether the background noise signal corresponds to a default noise category included in the plurality of noise categories. The plurality of noise categories may correspond to a plurality of environments in which the voice models (e.g., the first voice model 691 to the n-th voice model 693) of the voice signal are generated.

According to an embodiment, the default noise category may be a noise category corresponding to the voice recording environment. The default noise category may be a category corresponding to a noise signal recorded together with the voice of the speaker who recorded the voice. The default noise category is a noise category generated using a noise (e.g., the noise signal) recorded together with the voice wakeup command (e.g., the voice signal) when the speaker, who recorded the voice on the electronic device 600, inputs the voice wakeup command to the electronic device 600. The default noise category may be a category corresponding to the noise recognition model 651 loaded into the noise recognition module 650 by default.

According to an embodiment, the default noise category may be a category corresponding to the noise recognition model 651 loaded into the noise recognition module 650 after being used for the noise recognition in a previous stage, regardless of the voice recording environment.

According to an embodiment, when the background noise signal does not correspond to the default noise category, the noise recognition module 650 may determine whether the remaining categories among the plurality of noise categories except for the default noise category correspond to the background noise signal. For example, the noise recognition module 650 may determine whether the remaining categories except for the default noise category correspond to the background noise signal in the order of high mutual similarity.

For example, the noise recognition module 650 may measure a similarity between a noise model corresponding to the remaining categories among the plurality of noise models (e.g., the first noise model 681 to the n-th noise model 683) and the background noise signal, and determine a noise model having a highest similarity as the noise recognition model 651. In another example, the noise recognition module 650 may measure a similarity between a noise model corresponding to the remaining categories among the plurality of noise models (e.g., the first noise model 681 to the n-th noise model 683) and the background noise signal, and determine a noise model having a similarity greater than a predetermined threshold value as the noise recognition model 651. In this case, if a recognition score is lower than the predetermined threshold value when recognizing the background noise signal using the noise recognition model 651, the noise recognition module 650 may determine that the background noise signal does not correspond to an operating noise recognition model.

According to an embodiment, the noise recognition module 650 may be a single model or may include a plurality of sub-noise recognition models. For example, the noise recognition module 650 may include a plurality of sub-noise recognition models corresponding to the plurality of noise categories, respectively. In another example, the noise recognition module 650 may be a single model and may classify the plurality of noise categories and select one of the plurality of noise categories by using various methods (e.g., support vector machine (SVM), artificial neural net (ANN), vector quantization (VQ), hidden Markov model (HMM), and the like).

According to an embodiment, the noise recognition module 650 may transmit a result of determining whether the background noise signal corresponds to the plurality of noise categories to the obtaining module 670. For example, the result of determining whether the background noise signal corresponds to the plurality of noise categories may include a result of determining whether the background noise signal corresponds to the default noise category. The result of determining whether the background noise signal corresponds to the plurality of noise categories may further include a result of determining whether the other categories correspond to the background noise signal.

According to an embodiment, the obtaining module 670 may obtain (e.g., select or generate) a noise category of the background noise signal based on the result of determining whether the background noise signal corresponds to the plurality of noise categories. The obtaining module 670 may obtain a noise model of the background noise signal and a voice model of the voice signal based on the obtained noise category. The obtaining module 670 may determine the obtained voice model as the voice recognition model 671. The plurality of noise categories may have a one-to-one relationship with the plurality of voice models (e.g., the first voice model 691 to the n-th voice model 693).

According to an embodiment, when the background noise signal corresponds to the default noise category according to the determination result (e.g., the result of determining whether the background noise signal corresponds to the default noise category), the obtaining module 670 may obtain (e.g., select) the default noise category as the noise category of the background noise signal. The obtaining module 670 may obtain a noise model of the background noise signal and a voice model of the voice signal based on the obtained noise category. For example, the obtaining module 670 may obtain a noise recognition model loaded into the noise recognition module 650 by default as the noise recognition model 651 as it is, and obtain a voice recognition model loaded into the voice recognition module 660 by default as the voice recognition model 661 as it is.

According to an embodiment, the voice recognition model 661 loaded into the voice recognition module 660 by default may be a voice model corresponding to the voice recording environment. The voice recognition model 661 loaded into the voice recognition module 660 by default may be a voice model generated using the voice wakeup command (e.g., the voice signal) and the noise (e.g., the noise signal) recorded with the voice signal when a speaker, who recorded a voice on the electronic device 600, inputs the voice wakeup command to the electronic device 600. The voice recognition model 661 loaded into the voice recognition module 660 by default may correspond to the noise recognition model 651 loaded into the noise recognition module 650 by default.

According to an embodiment, when the background noise signal corresponds to a noise category of the remaining categories according to the determination result (e.g., the result of determining whether the remaining categories correspond to the background noise signal), the obtaining module 670 may obtain (e.g., select) the corresponding noise category as the noise category of the background noise signal. The obtaining module 670 may obtain (e.g., select) a voice model corresponding to the obtained (e.g., selected) noise category among the plurality of voice models (e.g., the first voice model 691 to the n-th voice model 693). The obtaining module 670 may determine the obtained (e.g., selected) voice model as the voice recognition model 661. The obtaining module 670 may load the voice recognition model 671 into the voice recognition module 660.

According to an embodiment, when the background noise signal does not correspond to all the noise categories according to the determination result (e.g., the result of determining whether the remaining categories correspond to the background noise signal), the obtaining module 670 may obtain (e.g., generate) a noise category of the background noise signal based on the background noise signal in real time. For example, the obtaining module 670 may obtain (e.g., generate) the noise category of the background noise signal in real time using one or a combination of two or more of SVM, ANN, HMM, or VQ.

According to an embodiment, the obtaining module 670 may obtain (e.g., generate) a voice model (e.g., a voice model of the voice signal) corresponding to the obtained (e.g., generated) noise category based on the obtained (e.g., generated) noise category in real time. For example, the obtaining module 670 may obtain (e.g., generate) the voice model of the voice signal in real time using one or a combination of two or more of SVM, ANN, HMM, or VQ. The obtaining module 670 may determine the obtained (e.g., generated) voice model as the voice recognition model 661. The obtaining module 670 may load the voice recognition model 661 into the voice recognition module 660.

According to an embodiment, the electronic device 600 continues to recognize the voice wakeup command even in a sleep state, and therefore, the electronic device 600 may continuously recognize a noise signal included in the voice wakeup command. The electronic device 600 may continuously perform periodic/aperiodic noise recognition even when the voice wakeup command is not uttered, and may obtain (e.g., select and/or generate) a noise category of an environment in which the electronic device 600 is currently located. Accordingly, the electronic device 600 may obtain a noise model and a voice model corresponding to the obtained noise category at any time.

According to an embodiment, the voice recognition module 660 may recognize a voice signal using the voice recognition model 661 of the voice signal. For example, the voice recognition module 660 may recognize a voice signal using the voice recognition module 660, into which the voice recognition model 661 of the voice signal is loaded.

According to an embodiment, the plurality of noise categories may correspond to a plurality of environments in which the voice models of the voice signal are generated. The plurality of noise categories may be generated based on background noise signals included in sound signals collected in the plurality of environments.

According to an embodiment, the plurality of noise models (e.g., the first noise model 681 to the n-th noise model 683) may be generated using one or a combination of two or more of SVM, ANN, HMM, or VQ. The plurality of noise models (e.g., the first noise model 681 to the n-th noise model 683) may have a one-to-one relationship with the plurality of noise categories. The plurality of noise models (e.g., the first noise model 681 to the n-th noise model 683) may have a one-to-one relationship with the plurality of voice models (e.g., the first voice model 691 to the n-th voice model 693).

According to an embodiment, the plurality of voice models (e.g., the first voice model 691 to the n-th voice model 693) may be generated based on voice signals and background noise signals included in sound signals collected in the plurality of environments. The plurality of voice models (e.g., the first voice model 691 to the n-th voice model 693) may be generated using one or a combination of two or more of SVM, ANN, HMM, or VQ.

According to an embodiment, the electronic device 600 may be implemented in a computing device, a machine-type communication device, an IoT device, a data server, or a portable device.

According to an embodiment, the portable device may be implemented as, for example, a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal or portable navigation device (PND), a handheld game console, an e-book, or a smart device. The smart device may be implemented as, for example, a smartwatch, a smart band, or a smart ring.

FIG. 7 is a diagram illustrating a sound signal including a voice signal and a background noise signal, according to an embodiment.

Referring to FIG. 7, a waveform 700 is a waveform of a sound signal. The sound signal may correspond to an utterance (e.g., the voice wakeup command, for example, “Hi, Bixby”) of a speaker. The speaker may be a user of an electronic device (e.g., the electronic device 101 of FIG. 1, the electronic device 201 of FIG. 2, the electronic device 500 of FIG. 5, or the electronic device 600 of FIG. 6).

According to an embodiment, the sound signal may include a voice signal corresponding to a voice of a speaker and a background noise signal. The background noise signal may correspond to an environment (e.g., the voice recording environment) in which the voice of the speaker is recorded on the electronic device (e.g., the electronic device 101 of FIG. 1, the electronic device 201 of FIG. 2, the electronic device 500 of FIG. 5, or the electronic device 600 of FIG. 6).

According to an embodiment, the waveform 700 may include a voice section 710 including the voice signal and a noise section not including the voice signal. The voice section 710 may further include the background noise signal of the sound signal.

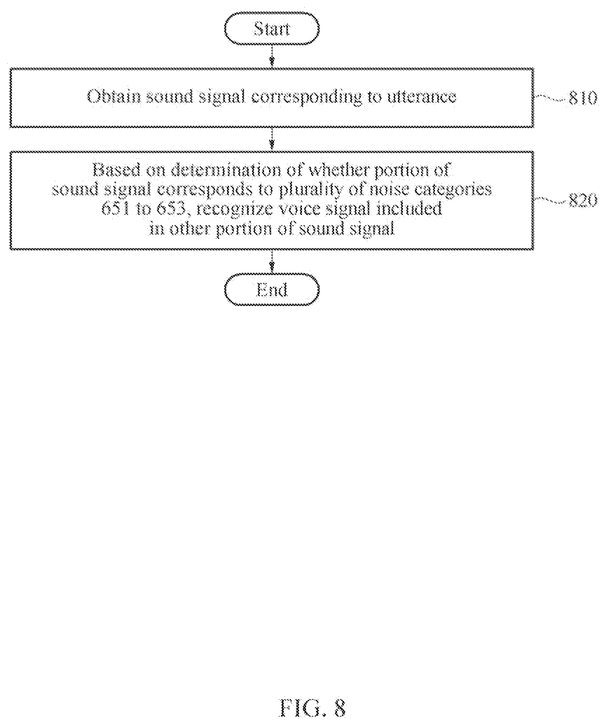

FIG. 8 is a flowchart illustrating a method of operating an electronic device, according to an embodiment.

Operation 810 and operation 820 may describe an operation of an electronic device (e.g., the electronic device 101 of FIG. 1, the electronic device 201 of FIG. 2, the electronic device 500 of FIG. 5, or the electronic device 600 of FIG. 6) recognizing a voice in an environment different from an environment in which a voice was recorded.

In operation 810, the electronic device may obtain a sound signal corresponding to an utterance (e.g., the voice wakeup command, for example, “Hi, Bixby”) of a speaker. The speaker may be a user of an electronic device (e.g., the electronic device 101 of FIG. 1, the electronic device 201 of FIG. 2, the electronic device 500 of FIG. 5, or the electronic device 600 of FIG. 6).

In operation 820, the electronic device may separate a background noise signal from the sound signal. The electronic device may determine whether a portion (e.g., the background noise signal) of the sound signal corresponds to a plurality of noise categories (e.g., a first noise category to an n-th noise category of FIG. 6). The electronic device may obtain (e.g., select or generate) a noise category of the background noise signal based on the determination of whether the background noise signal corresponds to the plurality of noise categories (e.g., the first noise category to the n-th noise category of FIG. 6). The electronic device may obtain (e.g., select or generate) a noise model of the background noise signal and a voice model of the voice signal based on the obtained noise category. The electronic device may determine the obtained noise model as the noise model of the background noise signal (e.g., the noise recognition model 651 of FIG. 6), and determine the obtained voice model as the voice model of the voice signal (e.g., the voice recognition model 661 of FIG. 6). The electronic device may recognize a voice signal using the voice recognition model 661. For example, the electronic device may load the voice recognition model 661 into the voice recognition module 660. The electronic device may recognize a voice signal using the voice recognition module 660 into which the voice recognition model 661 is loaded.

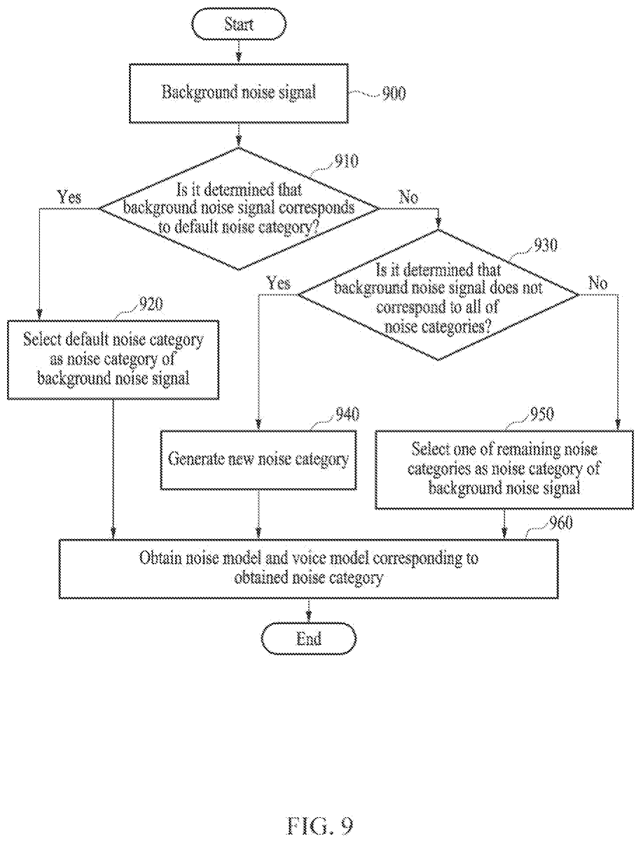

FIG. 9 is a flowchart illustrating operations of an electronic device obtaining a voice model of a voice signal, according to an embodiment.

Referring to FIG. 9, the operations may describe an operation of an electronic device (e.g., the electronic device 101 of FIG. 1, the electronic device 201 of FIG. 2, the electronic device 500 of FIG. 5, or the electronic device 600 of FIG. 6) obtaining, based on the determination of whether a portion (e.g., the background noise signal) of a sound signal corresponds to a plurality noise categories, a voice model of a voice signal included in another portion of the sound signal.

In operation 900, the electronic device may obtain (e.g., collect) a sound signal corresponding to an utterance (e.g., the voice wakeup command, for example, “Hi, Bixby”) of a speaker (e.g., a user of the electronic device). The electronic device may separate a background noise signal from the sound signal.

In operation 910, the electronic device may determine whether the background noise signal corresponds to a default noise category included in a plurality of noise categories.

When it is determined that the background noise signal corresponds to the default noise category included in the plurality of noise categories, the electronic device may perform operation 920.

When it is determined that the background noise signal does not correspond to the default noise category included in the plurality of noise categories, the electronic device may perform operation 930.

In operation 920, the electronic device may select the default noise category as a noise category of the background noise signal.

In operation 930, the electronic device may determine whether the background noise signal does not correspond to all the noise categories included in the plurality of noise categories. For example, the electronic device may determine whether the remaining categories except for the default noise category, among the plurality of noise categories in the order of a high mutual similarity with the background noise signal, corresponds to the background noise signal. For example, the electronic device may calculate an average of spectral distribution in a frequency domain of the background noise signal. The electronic device may calculate a Kullback-Leibler divergence (KLD) value between a spectral density function (SDF) corresponding to the plurality of noise categories and the spectral distribution of the background noise signals, and may determine that the background noise signal has a high mutual similarity with a corresponding noise category, as the KLD value therebetween is small. The electronic device may use various mutual similarity measurement methods other than the above method.

When it is determined that the background noise signal does not correspond to all of the noise categories, the electronic device may perform operation 940. When the background noise signal corresponds to one of the remaining categories, the electronic device may perform operation 950.

In operation 940, when the background noise signal does not correspond to all of the noise categories included in the plurality of noise categories (e.g., the first noise category to the n-th noise category of FIG. 6), the electronic device may obtain (e.g., generate) a noise category of the background noise signal based on the background noise signal in real time.

In operation 950, the electronic device may obtain (e.g., select) the noise category in the remaining categories determined to correspond to the background noise signal as the noise category of the background noise signal.

In operation 960, the electronic device may obtain (e.g., select and/or generate) a noise model of the background noise signal and a voice model of the voice signal based on the obtained (e.g., selected and/or generated) noise category. For example, when the electronic device generates a new noise category in operation 940, the electronic device may generate a noise model corresponding to the noise category of the background noise signal based on the spectral distribution of the background noise signals calculated in operation 920 or data obtained by processing (e.g., smoothing) the spectral distribution. The noise recognition module 650 of the electronic device may be a single model or may include a plurality of sub-noise recognition models. For example, the noise recognition module 650 may include a plurality of sub-noise recognition models corresponding to the plurality of noise categories, respectively. In another example, the noise recognition module 650 may be a single model and may select one of the plurality of noise categories by classifying the plurality of noise categories using various methods (e.g., SVM, ANN, VQ, and HMM).

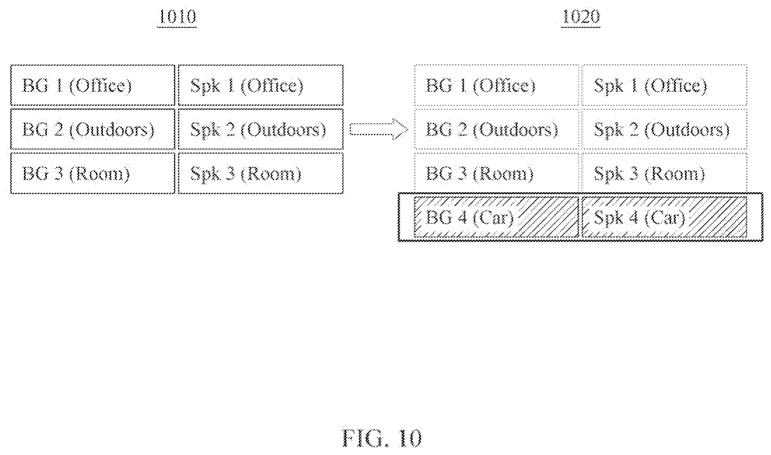

FIG. 10 is a diagram illustrating a plurality of noise models and a plurality of voice models, according to an embodiment.

Referring to FIG. 10, an electronic device (e.g., the electronic device 101 of FIG. 1, the electronic device 201 of FIG. 2, the electronic device 500 of FIG. 5, or the electronic device 600 of FIG. 6) may include a plurality noise categories. The plurality of noise categories may correspond to a plurality of environments in which voice models of voice signals included in sound signals are generated. The sound signal may correspond to an utterance (e.g., the voice wakeup command) of a speaker (e.g., a user of the electronic device). For example, as shown in table 1010, the plurality of noise categories may include an office noise category, an outdoor noise category, and a room noise category. The electronic device may include a plurality of noise models (e.g., the first noise model 681 to the n-th noise model 683 of FIG. 6) corresponding to the plurality of noise categories, respectively. For example, the plurality of noise models (e.g., the first noise model 681 to the n-th noise model 683) may include an office noise model, an outdoor noise model, and a room noise model.

According to an embodiment, the electronic device may include a plurality of voice models (e.g., the first voice model 691 to the n-th voice model 693 of FIG. 6). The plurality of voice models may correspond to a plurality of environments in which the voice signals included in the sound signals are recorded. The sound signal may correspond to an utterance (e.g., the voice wakeup command) of a speaker (e.g., a user of the electronic device). For example, as shown in table 1010, the plurality of voice models (e.g., the first voice model 691 to the n-th voice model 693) may include an office voice model, an outdoor voice model, and a room voice model. The office voice model, the outdoor voice model, and the room voice model included in the plurality of voice models (e.g., the first voice model 691 to the n-th voice model 693) may have one-to-one relationships with the office noise category, the outdoor noise category, and the room noise category included in the plurality of noise categories, respectively. The office voice model, the outdoor voice model, and the room voice model included in the plurality of voice models (e.g., the first voice model 691 to the n-th voice model 693) may have one-to-one relationships with the office noise model, the outdoor noise model, and the room noise model included in the plurality of noise models (e.g., the first noise model 681 to the n-th noise model 683), respectively.

According to an embodiment, when the speaker records a voice on the electronic device in an office, the electronic device may maintain or improve the voice wakeup command recognition performance even in an environment different from the office (e.g., outdoors, in a room, in a car, etc.). When the speaker records a voice on the electronic device in an office, a default noise category may be the office noise category.

For example, when the speaker inputs the voice wakeup command to the electronic device “outdoors”, the background noise signal (e.g., the background noise signal outdoors) corresponds the outdoor noise category of the remaining categories except for the default noise category among the plurality noise categories, and thus, the electronic device may obtain (e.g., select) the outdoor noise category as the noise category of the background noise signal. The electronic device may obtain (e.g., select) a voice model of the voice signal based on the selected noise category in real time.

In another example, as shown in table 1020, when the speaker inputs the voice wakeup command to the electronic device “in a car”, the background noise signal (e.g., the background noise signal in a car) does not correspond to all of the remaining categories except for the default noise category among the plurality noise categories, and thus, the electronic device may obtain (e.g., generate) a noise category (e.g., the car noise category) of the background noise signal based on the background noise signal (e.g., the background noise signal in a car) in real time. The electronic device may obtain (e.g., generate) a voice model of the voice signal based on the generated noise category in real time.

An electronic device 101, 201, 500, or 600 includes a memory 130, 207, or 610 including instructions, and a processor 120, 203, or 630 electrically connected to the memory 130, 207, or 610 and configured to execute the instructions. When the instructions are executed by the processor 120, 203, or 630, the processor 120, 203, or 630 is configured to obtain a sound signal corresponding to an utterance. When the instructions are executed by the processor 120, 203, or 630, the processor 120, 203, or 630 is configured to, based on determination of whether a portion of the sound signal corresponds to a plurality noise categories, recognize a voice signal included in the other portion of the sound signal. The plurality of noise categories corresponds to a plurality of environments in which voice models of voice signals are generated.

The plurality of noise categories may have a one-to-one relationship with the plurality of voice models (e.g., the first voice model 691 to the n-th voice model 693).

The processor 120, 203, or 630 may be configured to determine whether the portion corresponds to a default noise category included in the plurality of noise categories. The processor 120, 203, or 630 may be configured to obtain a noise category of the portion based on determination of whether the portion corresponds to the default noise category. The processor 120, 203, or 630 may be configured to obtain a noise model corresponding to the portion and a voice model corresponding to the voice signal based on the obtained noise category.

The processor 120, 203, or 630 may be configured to recognize the voice signal using the obtained voice model.

The processor 120, 203, or 630 may be configured to, when the portion does not correspond to a default noise category included in the plurality of noise categories, obtain a noise category of the portion based on the portion. The processor 120, 203, or 630 may be configured to obtain a noise model of the portion and a voice model of the voice signal based on the obtained noise category.

The processor 120, 203, or 630 may be configured to determine whether remaining categories except for the default noise category among the plurality of noise categories correspond to the portion in order of a highest mutual similarity.

The processor 120, 203 or 630 may be configured to, when the portion corresponds to a noise category of the remaining categories, select the corresponding noise category as the noise category of the portion.

The processor 120, 203, or 630 may be configured to, when the portion does not correspond to all of the plurality of noise categories, generate the noise category of the portion based on the portion in real time. The processor 120, 203, or 630 may be configured to generate the voice model based on the generated noise category.

An electronic device 101, 201, 500, or 600 includes a memory 130, 207, or 610 including instructions, and a processor 120, 203, or 630 electrically connected to the memory 130, 207, or 610 and configured to execute the instructions. When the instructions are executed by the processor 120, 203, or 630, the processor 120, 203, or 630 is configured to determine whether a noise category of a background noise signal included in a sound signal corresponds to at least one of a plurality of noise categories. When the instructions are executed by the processor 120, 203, or 630, the processor 120, 203, or 630 is configured to obtain a voice model of a voice signal included in the sound signal based on determination of whether the noise category corresponds to the at least one of the plurality of noise categories. When the instructions are executed by the processor 120, 203, or 630, the processor 120, 203, or 630 is configured to recognize the voice signal using the obtained voice model. The plurality of noise categories corresponds to a plurality of environments in which voice models of voice signals are generated.

The plurality of noise categories may have a one-to-one relationship with a plurality of voice models (e.g., the first voice model 691 to the n-th voice model 693).

The processor 120, 203, or 630 may be configured to determine whether the noise category corresponds to a default noise category included in the plurality of noise categories. The processor 120, 203, or 630 may be configured to obtain the noise category of the background noise signal based on the determination of whether the noise category corresponds to the default noise category. The processor 120, 203, or 630 may be configured to obtain a noise model of the background noise signal and a voice model based on the obtained noise category.

A method of operating an electronic device 101, 201, 500, or 600 includes obtaining a sound signal corresponding to an utterance. The method includes, based on determination of whether a portion of the sound signal corresponds to a plurality noise categories, recognizing a voice signal included in the other portion of the sound signal. The plurality of noise categories corresponds to a plurality of environments in which voice models of voice signals are generated.

The plurality of noise categories may have a one-to-one relationship with a plurality of voice models (e.g., the first voice model 691 to the n-th voice model 693).

The recognizing may include determining whether the portion corresponds to a default noise category included in the plurality of noise categories. The recognizing may include obtaining a noise category of the portion and a voice model of the voice signal based on determination of whether the portion corresponds to the default noise category.

The method may further include recognizing the voice signal using the obtained voice model.

The recognizing may include, when the portion does not correspond to a default noise category included in the plurality of noise categories, obtaining a noise category of the portion based on the portion. The recognizing may include obtaining a noise model of the portion and a voice model of the voice signal based on the obtained noise category.

The obtaining of the noise category of the portion may include determining whether remaining categories except for the default noise category among the plurality of noise categories correspond to the portion in order of a highest mutual similarity.

The determining in the order of the highest mutual similarity may include, when the portion corresponds to a noise category of the remaining categories, selecting the corresponding noise category as the noise category of the portion.

The determining in the order of the highest mutual similarity may include, when the portion does not correspond to all of the plurality of noise categories, generating the noise category of the portion based on the portion in real time. The obtaining of the voice model may include generating the voice model based on the generated noise category.

According to an aspect of the disclosure, an electronic device includes: a memory configured to store at least one instruction; and a processor electrically connected to the memory and configured to execute the at least one instruction to: obtain a sound signal corresponding to an utterance, and recognize a voice signal included in the sound signal, based on a determination that a portion of the sound signal corresponds to at least one of a plurality of noise categories, the plurality of noise categories corresponding to a plurality of environments in which a plurality of voice models of voice signals are generated.

The plurality of noise categories may have a one-to-one relationship with the plurality of voice models.

The processor may be further configured to execute the at least one instruction to: determine whether the portion of the sound signal corresponds to a default noise category in the plurality of noise categories; obtain a noise category of the portion of the sound signal, based on whether the portion of the sound signal corresponds to the default noise category; and obtain a noise model corresponding to the portion of the sound signal, and a voice model corresponding to the voice signal, based on the obtained noise category.

The processor may be further configured to execute the at least one instruction to: recognize the voice signal using the obtained voice model.

The processor may be further configured to execute the at least one instruction to: based on a determination that the portion of the sound signal does not correspond to a default noise category in the plurality of noise categories, obtain a noise category of the portion of the sound signal, and obtain a noise model corresponding to the portion of the sound signal, and a voice model of the voice signal, based on the obtained noise category.

The processor may be further configured to execute the at least one instruction to: determine whether a noise category in the plurality of noise categories, other than the default noise category, corresponds to the portion of the sound signal in order of a highest mutual similarity.

The processor may be further configured to execute the at least one instruction to: based on a determination that the noise category is in the plurality of noise categories, select a noise category of the portion of the sound signal.

The processor may be further configured to execute the at least one instruction to: based on a determination that the noise category is not in the plurality of noise categories; and generate the voice model based on the generated noise category, generate a noise category of the portion of the sound signal in real time.

According to an aspect of the disclosure, an electronic device includes: a memory configured to store at least one instruction; and a processor electrically connected to the memory and configured to execute the at least one instruction to: determine whether a noise category of a background noise signal included in a sound signal corresponds to at least one of a plurality of noise categories, the plurality of noise categories corresponding to a plurality of environments in which a plurality of voice models of voice signals are generated, obtain a voice model of a voice signal included in the sound signal based on a determination that the noise category of the background noise signal corresponds to the at least one of the plurality of noise categories, and recognize the voice signal using the obtained voice model.

The plurality of noise categories may have a one-to-one relationship with the plurality of voice models.

The processor may be further configured to execute the at least one instruction to: determine whether the noise category corresponds to a default noise category in the plurality of noise categories; obtain the noise category of the background noise signal based on whether the noise category corresponds to the default noise category; and obtain a noise model of the background noise signal and the voice model of the voice signal based on the obtained noise category.

According to an aspect of the disclosure, a method of operating an electronic device includes: obtaining a sound signal corresponding to an utterance; and recognizing a voice signal included in the sound signal, based on a determination that a portion of the sound signal corresponds to at least one of a plurality of noise categories, the plurality of noise categories corresponding to a plurality of environments in which a plurality of voice models of voice signals are generated.

The plurality of noise categories may have a one-to-one relationship with the plurality of voice models.

The recognizing the voice signal included in the sound signal may include: determining whether the portion of the sound signal corresponds to a default noise category in the plurality of noise categories; obtaining a noise category of the portion of the sound signal based on whether the portion of the sound signal corresponds to the default noise category; and obtaining a noise model of the portion of the sound signal, and a voice model of the voice signal, based on the obtained noise category.

The recognizing the voice signal included in the sound signal may include: recognizing the voice signal using the obtained voice model.

The recognizing the voice signal included in the sound signal may include: on a determination that the portion of the sound signal does not correspond to a default noise category in the plurality of noise categories, obtaining a noise category of the portion of the sound signal; and obtaining a noise model corresponding to the portion of the sound signal, and a voice model of the voice signal, based on the obtained noise category.

The obtaining the noise category of the portion may include: determining a noise category in the plurality of noise categories, other than the default noise category, that corresponds to the portion of the sound signal in order of a highest mutual similarity.

The determining the noise category in order of the highest mutual similarity may include: selecting a noise category of the portion of the sound signal, based on a determination that the noise category is in the plurality of noise categories.

The determining the noise category in order of the highest mutual similarity may include: generating a noise category of the portion of the sound signal in real time, based on a determination that the noise category is not in the plurality of noise categories, wherein the voice model of the voice signal may be obtained by generating the voice model based on the generated noise category.

According to an aspect of the disclosure, a non-transitory computer-readable medium stores computer readable program code or instructions which are executable by a processor to perform a method of operating an electronic device. The method includes: obtaining a sound signal corresponding to an utterance; and recognizing a voice signal included in the sound signal, based on a determination that a portion of the sound signal corresponds to at least one of a plurality of noise categories, the plurality of noise categories corresponding to a plurality of environments in which a plurality of voice models of voice signals are generated.

The electronic device according to the embodiments disclosed herein may be one of various types of electronic devices. The electronic device may include, for example, a portable communication device (e.g., a smart phone), a computer device, a portable multimedia device, a portable medical device, a camera, a wearable device, or a home appliance device. According to an embodiment of the disclosure, the electronic device is not limited to those described above.

It should be understood that various embodiments of the present disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” may include any one of the items listed together in the corresponding one of the phrases, or all possible combinations thereof. Terms such as “1^{st},” and “2^{nd},” or “first” or “second” may simply be used to distinguish the component from other components in question, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., by wire), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least portion of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

The embodiments of the present disclosure have been shown and described above with reference to the accompanying drawings. The embodiments disclosed in the specification and drawings are only intended to provide specific examples for easily describing the technical content of the disclosure and for assisting understanding of the disclosure, and are not intended to limit the scope of the disclosure. It will be understood by those of ordinary skill in the art that the present disclosure may be easily modified into other detailed forms without changing the technical principle or essential features of the present disclosure, and without departing from the gist of the disclosure as claimed by the appended claims and their equivalents. Therefore, it should be interpreted that the scope of the disclosure includes all changes or modifications derived based on the technical idea of the disclosure in addition to the embodiments disclosed herein.

What is claimed is:

1. An electronic device comprising:
a memory storing at least one instruction; and
a processor operatively connected to the memory and configured to execute the at least one instruction to:
obtain a sound signal corresponding to an utterance; and
recognize a voice signal included in the sound signal, based on a determination that a portion of the sound signal corresponds to at least one of a plurality of noise categories, the plurality of noise categories corresponding to a plurality of environments in which a plurality of voice models of voice signals are generated.

2. The electronic device of claim 1, wherein the plurality of noise categories has a one-to-one relationship with the plurality of voice models.

3. The electronic device of claim 1, wherein the processor is further configured to execute the at least one instruction to:
determine whether the portion of the sound signal corresponds to a default noise category in the plurality of noise categories;
obtain a noise category of the portion of the sound signal, based on a result of the determination of whether the portion of the sound signal corresponds to the default noise category; and
obtain a noise model corresponding to the portion of the sound signal, and a voice model corresponding to the voice signal, based on the obtained noise category.

4. The electronic device of claim 3, wherein the processor is further configured to execute the at least one instruction to:
recognize the voice signal using the obtained voice model.

5. The electronic device of claim 2, wherein the processor is further configured to execute the at least one instruction to:
based on a determination that the portion does not correspond to a default noise category included in the plurality of noise categories, obtain a noise category of the portion of the sound signal; and
obtain a noise model corresponding to the portion of the sound signal and a voice model of the voice signal, based on the obtained noise category.

6. The electronic device of claim 5, wherein the processor is further configured to execute the at least one instruction to:
determine whether a noise category in the plurality of noise categories, other than the default noise category, corresponds to the portion of the sound signal in order of a highest mutual similarity.

7. The electronic device of claim 6, wherein the processor is further configured to execute the at least one instruction to:
based on a determination that the noise category is in the plurality of noise categories, select a noise category of the portion of the sound signal.

8. The electronic device of claim 6, wherein the processor is further configured to execute the at least one instruction to:
based on a determination that the noise category is not in the plurality of noise categories, generate a noise category of the portion of the sound signal in real time; and
generate the voice model based on the generated noise category.

9. An electronic device comprising:
a memory configured to store at least one instruction; and
a processor operatively connected to the memory and configured to execute the at least one instruction to:
determine whether a noise category of a background noise signal included in a sound signal corresponds to at least one of a plurality of noise categories, the plurality of noise categories corresponding to a plurality of environments in which a plurality of voice models of voice signals are generated,
obtain a voice model of a voice signal included in the sound signal based on a determination that the noise category of the background noise signal corresponds to the at least one of the plurality of noise categories, and
recognize the voice signal using the obtained voice model.

10. The electronic device of claim 9, wherein the plurality of noise categories has a one-to-one relationship with the plurality of voice models.

11. The electronic device of claim 9, wherein the processor is further configured to execute the at least one instruction to:
determine whether the noise category corresponds to a default noise category in the plurality of noise categories;
obtain the noise category of the background noise signal based on a result of the determination of whether the noise category corresponds to the default noise category; and
obtain a noise model of the background noise signal and the voice model of the voice signal based on the obtained noise category.

12. A method of operating an electronic device comprising:
obtaining a sound signal corresponding to an utterance; and
recognizing a voice signal included in the sound signal, based on a determination that a portion of the sound signal corresponds to at least one of a plurality of noise categories, the plurality of noise categories corresponding to a plurality of environments in which a plurality of voice models of voice signals are generated.

13. The method of claim 12, wherein the plurality of noise categories has a one-to-one relationship with the plurality of voice models.

14. The method of claim 12, wherein the recognizing the voice signal included in the sound signal comprises:
determining whether the portion of the sound signal corresponds to a default noise category in the plurality of noise categories;
obtaining a noise category of the portion of the sound signal based on whether the portion of the sound signal corresponds to the default noise category; and
obtaining a noise model of the portion of the sound signal, and a voice model of the voice signal, based on the obtained noise category.

15. The method of claim 14, wherein the recognizing the voice signal included in the sound signal comprises:
recognizing the voice signal using the obtained voice model.

16. The method of claim 13, wherein the recognizing the voice signal included in the sound signal comprises: based on a determination that the portion of the sound signal does not correspond to a default noise category in the plurality of noise categories,
obtaining a noise category of the portion of the sound signal; and
obtaining a noise model corresponding to the portion of the sound signal, and a voice model of the voice signal, based on the obtained noise category.

17. The method of claim 16, wherein the obtaining the noise category of the portion comprises:
determining a noise category in the plurality of noise categories, other than the default noise category, that corresponds to the portion of the sound signal in order of a highest mutual similarity.

18. The method of claim 17, wherein the determining the noise category in order of the highest mutual similarity comprises:
based on a determination that the noise category is in the plurality of noise categories, selecting a noise category of the portion of the sound signal.

19. The method of claim 17, wherein the determining the noise category in order of the highest mutual similarity comprises:
based on a determination that the noise category is not in the plurality of noise categories, generating a noise category of the portion of the sound signal in real time, and
wherein the obtaining of the voice model of the voice signal comprises generating the voice model based on the generated noise category.
